(19) United States
(12) Patent Application Publication
(10) Pub. No.: US 2025/0077286 A1
(43) Pub. Date: Mar. 6, 2025

(54) MEM-COPY INSTRUCTION QUASHING

(71) Applicant: Arm Limited, Cambridge (GB)

(72) Inventors: Sharjeel SAEED, Cambridge (GB); Karel Hubertus Gerardus WALTERS, Cambridge (GB); Zifan WANG, Cambridge (GB); Samuel William COLLISS, Bottisham (GB)

(21) Appl. No.: 18/456,621

(22) Filed: Aug. 28, 2023

(51) Int. Cl. G06F 9/50

(52) U.S. Cl. CPC G06F 9/5027

(57) ABSTRACT

An apparatus is provided for improving the use of multiple-issue operations in a data processor. A variable-issue operation can be recognised is being either a single-issue operation or a multiple-issue operation in dependence on the state of the program at runtime. If a variable-issue operation can be scheduled as a multiple-issue operation, then other operations can be scheduled for performance in the same cycle, when they would have otherwise had to be scheduled for a later cycle. As such, more operations can be performed in fewer cycles thus improving code density and improving data processing performance.

### TECHNICAL FIELD

The present disclosure relates to data processing, and in particular relates to issuing or scheduling data processing operations.

### DESCRIPTION

It is desirable to schedule multiple operations to in an overlapping (or parallel) manner where possible.

### SUMMARY

Viewed from a first example configuration, there is provided an apparatus comprising: scheduling circuitry configured to schedule one or more operations to be performed in at least a given cycle; determination circuitry configured to identify one of the one or more operations as a variable-issue operation and to perform a determination of whether the variable-issue operation is a single-issue operation or a multiple-issue operation; the scheduling circuitry is configured to schedule the variable-issue operation to be performed in at least the given cycle, wherein in response to the determination being that the variable-issue operation is the single-issue operation, the determination circuitry is configured to cause the scheduling circuitry to suppress scheduling of the one or more operations other than the variable-issue operation to be performed in at least the given cycle; and in response to the determination being that the variable-issue operation is the multiple-issue operation, the determination circuitry is configured to cause the scheduling circuitry to schedule at least one of the one or more operations other than the variable-issue operation to be performed in at least the given cycle.

Viewed from a second example configuration, there is provided a method comprising: scheduling one or more operations to be performed in at least a given cycle; identifying one of the one or more operations as a variable-issue operation and performing a determination of whether the variable-issue operation is a single-issue operation or a multiple-issue operation; scheduling the variable-issue operation to be performed in at least the given cycle, wherein in response to the determination being that the variable-issue operation is the single-issue operation, suppressing scheduling of the one or more operations other than the variable-issue operation to be performed in at least the given cycle; and in response to the determination being that the variable-issue operation is the multiple-issue operation, scheduling at least one of the one or more operations other than the variable-issue operation to be performed in at least the given cycle.

Viewed from a third example configuration, there is provided a system comprising: an apparatus comprising: scheduling circuitry configured to schedule one or more operations to be performed in at least a given cycle; determination circuitry configured to identify one of the one or more operations as a variable-issue operation and to perform a determination of whether the variable-issue operation is a single-issue operation or a multiple-issue operation; the scheduling circuitry is configured to schedule the variable-issue operation to be performed in at least the given cycle, wherein in response to the determination being that the variable-issue operation is the single-issue operation, the determination circuitry is configured to cause the scheduling circuitry to suppress scheduling of the one or more operations other than the variable-issue operation to be performed in at least the given cycle; and in response to the determination being that the variable-issue operation is the multiple-issue operation, the determination circuitry is configured to cause the scheduling circuitry to schedule at least one of the one or more operations other than the variable-issue operation to be performed in at least the given cycle, implemented in at least one packaged chip; at least one system component; and a board, wherein the at least one packaged chip and the at least one system component are assembled on the board.

Viewed from a fourth example configuration, there is provided a chip-containing product comprising a system comprising: apparatus comprising: scheduling circuitry configured to schedule one or more operations to be performed in at least a given cycle; determination circuitry configured to identify one of the one or more operations as a variable-issue operation and to perform a determination of whether the variable-issue operation is a single-issue operation or a multiple-issue operation; the scheduling circuitry is configured to schedule the variable-issue operation to be performed in at least the given cycle, wherein in response to the determination being that the variable-issue operation is the single-issue operation, the determination circuitry is configured to cause the scheduling circuitry to suppress scheduling of the one or more operations other than the variable-issue operation to be performed in at least the given cycle; and in response to the determination being that the variable-issue operation is the multiple-issue operation, the determination circuitry is configured to cause the scheduling circuitry to schedule at least one of the one or more operations other than the variable-issue operation to be performed in at least the given cycle, assembled on a further board with at least one other product component.

Viewed from a fifth example configuration, there is provided a non-transitory computer-readable medium to store computer-readable code for fabrication of an apparatus comprising: scheduling circuitry configured to schedule one or more operations to be performed in at least a given cycle; determination circuitry configured to identify one of the one or more operations as a variable-issue operation and to perform a determination of whether the variable-issue operation is a single-issue operation or a multiple-issue operation; the scheduling circuitry is configured to schedule the variable-issue operation to be performed in at least the given cycle, wherein in response to the determination being that the variable-issue operation is the single-issue operation, the determination circuitry is configured to cause the scheduling circuitry to suppress scheduling of the one or more operations other than the variable-issue operation to be performed in at least the given cycle; and in response to the determination being that the variable-issue operation is the multiple-issue operation, the determination circuitry is configured to cause the scheduling circuitry to schedule at least one of the one or more operations other than the variable-issue operation to be performed in at least the given cycle.

### BRIEF DESCRIPTION OF THE DRAWINGS

The present invention will be described further, by way of example only, with reference to embodiments thereof as illustrated in the accompanying drawings, in which:

FIG. 1 schematically illustrates a data processing apparatus comprising an apparatus according to one aspect of the present techniques;

FIGS. 2A and 2B schematically illustrate an apparatus according to one aspect of the present techniques;

FIG. 3 illustrates a flow diagram of determining whether a variable-issue operation is single-issue or multiple-issue, according to one aspect of the present techniques;

FIG. 4 illustrates a plurality of instructions being scheduled for execution by different execution units;

FIG. 5 illustrates a stream of memory block copy instructions and an associated flow diagram for determining a number of bytes to be operated on by the variable-issue operation;

FIGS. 6A, 6B and 6C schematically illustrate segments of memory specified by memory block instructions of different sizes;

FIG. 7 illustrates how operations in an issue queue are identified to determine whether a variable-issue operation is single-issue or multiple-issue;

FIGS. 8A and 8B schematically illustrate operations being scheduled in a plurality of processing queues according to one aspect of the present techniques;

FIG. 9 illustrates a flow diagram for determining a number of bytes to be operated on by the variable-issue operation according to another aspect of the present techniques;

FIG. 10 schematically illustrates operations being scheduled in a plurality of processing queues according to another aspect of the present techniques;

FIG. 11 illustrates a system and a chip-containing product.

### DESCRIPTION OF EXAMPLE EMBODIMENTS

Before discussing the embodiments with reference to the accompanying figures, the following description of embodiments is provided.

In accordance with one example configuration there is provided apparatus comprising: scheduling circuitry configured to schedule one or more operations to be performed in at least a given cycle; determination circuitry configured to identify one of the one or more operations as a variable-issue operation and to perform a determination of whether the variable-issue operation is a single-issue operation or a multiple-issue operation; the scheduling circuitry is configured to schedule the variable-issue operation to be performed in at least the given cycle, wherein in response to the determination being that the variable-issue operation is the single-issue operation, the determination circuitry is configured to cause the scheduling circuitry to suppress scheduling of the one or more operations other than the variable-issue operation to be performed in at least the given cycle; and in response to the determination being that the variable-issue operation is the multiple-issue operation, the determination circuitry is configured to cause the scheduling circuitry to schedule at least one of the one or more operations other than the variable-issue operation to be performed in at least the given cycle.

When scheduling one or more operations to be performed (e.g. issued, sent for execution, or executed) in parallel during at least a given cycle, it is necessary to determine how many operations can be scheduled for the same cycle(s). In some examples, an operation may only be performed (e.g. issued) if there are no other operations being performed (e.g. issued) in the same cycle(s) (referred to as a single-issue operation herein). For example, operations may be scheduled in one or more processing queues to be performed in at least the given cycle. When a single-issue operation is scheduled to a processing queue, the scheduling of other operations to be performed in the same cycle is suppressed. For operations that are performed over several cycles, the suppression may continue for the duration of those cycles. This reduces performance since the opportunity for parallel issuing of the operations, also referred to as issue bandwidth, is reduced. In other examples, an operation may be performed alongside other operations in the same cycle(s) (referred to as a multiple-issue operation herein). When a multiple-issue operation is scheduled to one of multiple processing queues, the scheduling of other operations to other processing queues is permitted. Alternatively, where there is only a single processing queue, the multiple-issue operation may include an indicator to indicate that one or more later operations in the queue are to be performed in the same cycle. This enables more opportunities for parallel processing, thus increasing the issue bandwidth and improving performance.

In these examples, an “operation” may refer to a macro-operation that is cracked into one or more micro-operations or may refer to the micro-operations (or operations) themselves. In some examples, a single-issue macro-operation may be cracked into multiple-issue micro-operations. An “operation” may also refer to a fused operation that is generated from fusing two or more operations. Accordingly, these operations described herein may have a one-to-one, one-to-many or many-to-one relationship with instructions being executed as part of a program. When such operations are performed, they may be performed within a single cycle or over a plurality of cycles, depending on the implemented micro-architecture.

In accordance with the present techniques, there is provided determination circuitry which identifies a variable-issue operation. A variable-issue operation is an operation that could be scheduled as either a single-issue operation or multiple-issue operation, for example in dependence on the state of the program at runtime. For example, in some circumstances the variable-issue operation can be scheduled as a multiple-issue operation, whereas in other circumstances the same variable-issue operation is only able to be scheduled as a single-issue operation. In some examples, whether the variable-issue operation is a single-issue or multiple-issue operation is unknown up to the point that the variable-issue operation is scheduled. Accordingly, the determination circuitry is configured to determine whether the variable-issue operation is to be scheduled as a single-issue or multiple-issue operation. The determination circuitry may identify the variable-issue operation when or after it has been generated by decoding circuitry. For example, the determination circuitry may monitor an issue queue in which the variable-issue operation is placed along with one or more other operations ready to be scheduled for performance by, for example, execution circuitry. Alternatively, the determination circuitry may monitor a stream of instructions and recognise that the operation required by a particular instruction will be a variable-issue operation.

By performing the above determination, it is possible to schedule operations as multiple-issue operations more frequently where they would otherwise have been scheduled as single-issue operations. In other words, operations that would otherwise have required several cycles to can be compressed into a single cycle. Accordingly, this advantageously allows for parallel processing to be restored for at least the given cycle since additional operations may be scheduled to the other processing queues in that cycle. Over a number of cycles, this results in significant improvements in performance.

In some examples, the apparatus comprises execution circuitry configured to perform scheduled operations; and the determination circuitry is configured to perform the determination by detecting whether the variable-issue operation and the at least one of the one or more operations other than the variable-issue operation can be performed by the execution circuitry in at least the given cycle.

In such examples, is it recognised that certain types of operations require use of more execution resources than others. For example, a branch operation may be a simple check of a conditional flag which requires fewer execution resources than, for example an arithmetic operation requiring several source/destination registers and use of an arithmetic logic unit. If two operations both required use of the same execution resources, then there would be a conflict if they were both performed in the same cycle. Accordingly, it is useful to check the execution resources required for a variable-issue operation and at least one other operation to determine whether they could both be performed in the same cycle. As such, the determination may be performed by determining whether the variable-issue operation is capable of being performed in the same cycle as another pending operation. If so, then parallel processing can be restored as described above.

In some examples, the execution circuitry comprises a plurality of operational units; and in response to the variable-issue operation requiring use of a threshold number of the operational units, the determination circuitry is configured to perform the determination such that the determination is that the variable-issue operation is a single-issue operation.

In such examples, the operational units may comprise any one or more of an arithmetic logic unit, a floating point unit, branch unit, and a load/store unit. A threshold number is implemented to define the limit on how many operational units can be used by one operation while at least one other operation is being executed. This will be dependent on a particular implementation, in some examples, the threshold number will be half of the total number of operational units. If the variable-issue operation requires use of over half of the available operational units, then it can be quickly determined that another operation cannot be performed in the same cycle. Accordingly, the variable-issue operation is scheduled as a single-issue operation.

In some examples, in response to the variable-issue operation: being logically equivalent to a NOP, operation or being operationally null, or having nothing to do; the determination circuitry is configured to perform the determination and determine that the variable-issue operation is the multiple-issue operation.

A no-operation (NOP) is an operation that does nothing when it is performed. For example, a NOP does not change the state of any software-accessible registers, flags or data in memory. An operation may be described as logically equivalent to a NOP if that operation also does not change the state of any software-accessible registers, flags or data in memory, despite not being decoded as a NOP. An operation being operationally null may include updating registers, flags or data in memory in a way that does not do anything. For example, adding zero to a value in a register or setting a status flag to ‘true’ when it is already ‘true’. The circumstances at runtime may also be such that the variable-issue operation simply has nothing to do. For example, the actions required of the variable-issue operation may have already been done by the time the variable-issue operation is being scheduled.

If the variable-issue operation were then scheduled as a single-issue operation in these examples, then all of the processing queues would be effectively doing nothing, thus delaying any further execution of the program for at least the given cycle. It will be appreciated that an operation that is logically equivalent to a NOP, operationally null, and an operation that does not do anything can be scheduled as a multiple-issue operation, since any other operation can be performed in at least the same cycle. Accordingly, the determination circuitry is responsive to such circumstances to cause the variable-issue operation to be scheduled as a multiple-issue operation, thus allowing other operations to be performed in at least the given cycle and restoring parallel processing.

In some examples, the variable-issue operation is configured, when executed, to operate on a controllable number of bytes of a memory; and the determination circuitry is configured to perform the determination and determine that the variable-issue operation is the multiple-issue operation in response to the controllable number of bytes on which the variable-issue operation is performed being zero.

In such examples, the variable-issue operation, when performed, includes operating on a number of bytes in memory. This may include reading or writing data to a contiguous block of memory addresses, the size of which is identified by the controllable number of bytes. The number of bytes is controllable in that it is dependent on software and hence controllable, at least indirectly, by a programmer. For example an instruction may explicitly define the number of bytes to be operated on by the variable-issue operation. Alternatively, the controllable number of bytes may set by a previously performed operation. In such examples, it is possible that the controllable number of bytes is only known at runtime. The determination circuitry is configured to determine the controllable number of bytes and to check if it is equal to zero. If so, then it can be determined that the variable-issue operation would not actually be doing anything. Accordingly, the variable-issue operation is scheduled as a multiple-issue operation to allow other operations to be performed in that cycle.

In some examples, in response to the determination that the variable-issue operation is the multiple-issue operation, the scheduling circuitry is configured to schedule the variable-issue operation as a null operation to be performed in at least the given cycle.

In such examples, if the variable-issue operation is determined to be logically equivalent to a NOP, operationally null or would otherwise not do anything, it is replaced with a null operation by the scheduling circuitry. A null operation is a multiple-issue operation, since it can be executed in parallel because it does not require use of any execution resources. Accordingly, any other operation may be scheduled for the same cycle as a null operation, allowing that other operation to be performed a cycle earlier than it otherwise would have been.

In some examples, the determination circuitry is configured to identify a prologue operation preceding the variable-issue operation; and the determination circuitry is configured to perform the determination and determine that the variable-issue operation is the multiple-issue operation in response to an extent to which the prologue operation is performed.

In such examples, it is recognised that some operations are performed in a predictable sequence where the variable-issue operation is preceded by a prologue operation. In these examples, whether or not the variable-issue operation will do anything is dependent on what the prologue operation does. Accordingly, the determination circuitry is configured to determine what the prologue operation will do in order to determine whether the variable-issue operation will do anything, and hence whether the variable-issue operation is to be a single-issue or multiple-issue operation.

In particular, where the extent to which the prologue operation is performed defines the extent to which the variable-issue operation will be performed, the prologue operation could be performed to the extent that the variable-issue operation will not do anything. Accordingly, the variable-issue operation can be determined to be a multiple-issue operation.

In some examples, the prologue operation is configured, when performed, to operate on an initial number of bytes of the memory; and the determination circuitry is configured to perform the determination and determine that the variable-issue operation is the multiple-issue operation in response to the initial number of bytes being such that there is nothing left for the variable-issue operation to do.

In such examples, the variable-issue operation is performed on a number of bytes that are leftover after the prologue operation is performed on the initial number of bytes. The initial number of bytes therefore represents the extent to which the prologue operation is performed as described in previous examples. The determination circuitry can therefore use the initial number of bytes to determine whether there will be anything left for the variable-issue operation to do. If not, then the variable-issue operation is determined to be a multiple-issue operation, thus enabling parallel processing in at least the given cycle.

In some examples, the prologue operation and the variable-issue operation are generated in response to decoding of at least one memory block instruction indicating a total number of bytes of the memory.

In such examples, the prologue operation and the variable-issue operation are to be performed on the total number of bytes indicated in the memory block instruction. The memory block instruction may be a single instruction that is decoded into prologue and variable-issue operations. Alternatively, there may be a plurality of memory block instructions, including a prologue instruction and a main instruction which are decoded into the prologue operation and variable-issue operation respectively. The memory block instructions may indicate the total number of bytes by encoding the value directly into the instruction or by reference to a source register that stores the value.

In some examples, the memory block instruction is either a memory block copy instruction or a memory block set instruction. A memory block copy instruction specifies a number of contiguous bytes to be copied from one region of memory to another. A memory block set instruction specifies a number of contiguous bytes which are set to a specified value or to a specified sequence of values. Such instructions are typically broken down into at least prologue and main (corresponding to variable-issue) operations in order to perform the required operation efficiently across a memory block.

In some examples, the determination circuitry is configured to perform the determination and determine that the variable-issue operation is the multiple-issue operation in response to the prologue operation operating on all of the total number of bytes of the memory.

In such examples, the total number of bytes indicated by the one or more memory block instructions is to be operated on by a combination of the prologue operation and the variable-issue operation. If the initial number of bytes on which the prologue operation is performed is equal to or greater than the total number of bytes, then it can be determined that the variable-issue operation will not have anything left to do. Accordingly, the variable-issue operation can be scheduled as a multiple-issue operation, thus enabling parallel processing in at least the given cycle.

In some examples, the prologue operation is configured to perform an alignment process such that the variable-issue operation, when performed, is aligned with a memory boundary, and the determination circuitry is configured to perform the determination and determine that the variable-issue operation is the multiple-issue operation in response to the alignment process comprising operating on all of the total number of bytes of memory.

In most memory systems, memory operations are performed between defined boundaries which are positioned at regular intervals (e.g. every 32 bytes). In order to perform alignment, the required memory operation is performed up to one of these memory boundaries. Subsequent operations can then operate between memory boundaries which is more efficient. Accordingly, if the alignment results in the prologue operation being performed on the total number of bytes or more, then it follows that that the variable-issue operation will not have anything left to do. Accordingly, the variable-issue operation can be scheduled as a multiple-issue operation, thus enabling parallel processing in at least the given cycle.

In some examples, the determination circuitry is configured to identify an epilogue operation following the variable-issue operation; the determination circuitry is configured to perform a further determination of whether the epilogue operation is the single-issue operation or the multiple-issue operation in response to a behaviour of the variable-issue operation.

In such examples, the sequence of operations will also include an epilogue operation following the variable-issue operation. The epilogue operation may be performed on a number of bytes that are left after the prologue and variable-issue operations are performed in order to verify that all of the total number of bytes have been operated upon. Accordingly, the extent to which the epilogue operation needs to be performed is dependent on the extent to which the prologue and/or variable-issue operations are performed. Hence, the epilogue operation is also identified as a variable-issue operation, and so may be issued as either a single-issue or multiple-issue operation. The dependence on the behaviour of the variable-issue operation in these examples may be similar to the above-described dependence on the behaviour of the prologue operation.

In some examples, the determination circuitry is configured to perform the further determination and determine that the epilogue operation is the multiple-issue operation in response to the determination being that the variable-issue operation is the multiple-issue operation.

In such examples, since the epilogue operation is performed on a number of bytes that are left after the prologue and variable-issue operations, if the above-described determination is that the variable-issue operation has nothing to do, it logically follows that the epilogue operation will also have nothing to do. Hence the epilogue operation is also determined to be a multiple-issue operation, thus enabling parallel processing in a cycle following at least the given cycle.

In some examples, the determination circuitry is configured to perform the further determination and determine that the epilogue operation is the multiple-issue operation in response to the variable-issue operation being performed to an extent such that there is nothing left for the epilogue operation to do.

In such examples, if the variable-issue operation is performed (i.e. is not determined to have nothing to do), then a further determination is performed to check whether the epilogue operation that follows will have anything to do. Similarly to previous examples, if the epilogue operation has nothing to do, then it can be determined to be a multiple-issue operation, thus enabling parallel processing in a cycle following the at least given cycle.

In some examples, the prologue operation, the variable-issue operation and the epilogue operation are generated in response to decoding of at least one memory block instruction indicating a total number of bytes of the memory; the determination circuitry is configured to perform the determination and determine that the variable-issue operation is the multiple-issue operation in response to the total number of bytes being less than or equal to 1; and the determination circuitry is configured to perform the further determination and determine that the epilogue operation is the multiple-issue operation in response to the total number of bytes being less than or equal to an alignment boundary interval plus 1.

In such examples, the determination can be performed more quickly by not considering how much alignment is required. In particular, if the total number of bytes is less than or equal to 1, then any amount of alignment will always operate on the total number of bytes. Therefore, it is known with certainty that the variable-issue operation will not do anything even without knowing how much alignment is actually required. Accordingly, the determination circuitry determines that the variable-issue operation is to be a multiple-issue operation. Similarly, if the total number of bytes is less than or equal to an alignment boundary interval plus 1, then the prologue operation and the variable-issue operation will operate on the total number of bytes. Therefore it is known that the epilogue operation will not do anything even without knowing how much alignment is actually required. Accordingly, the determination circuitry determines that the epilogue operation is to be a multiple-issue operation.

Particular embodiments will now be described with reference to the figures.

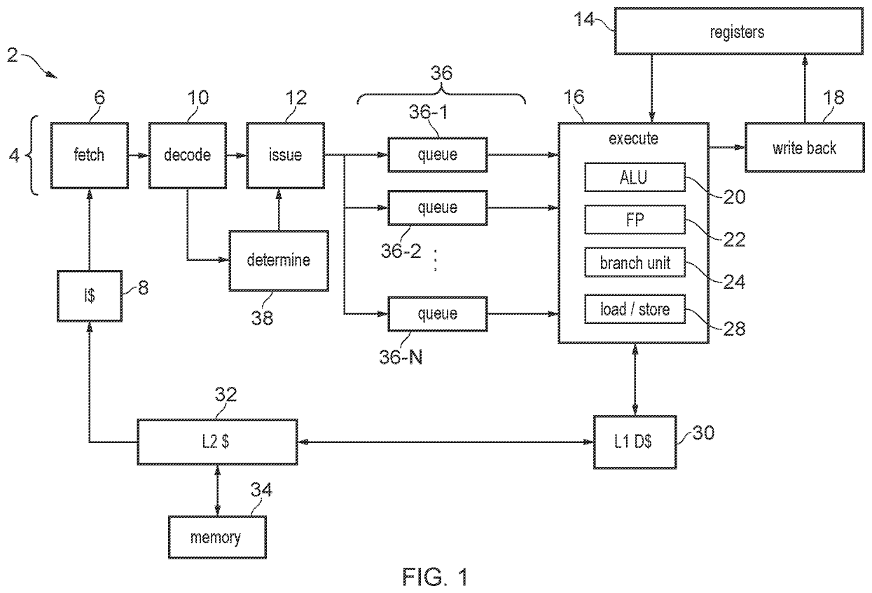

FIG. 1 schematically illustrates an example of a data processing apparatus 2. The data processing apparatus 2 has a number of pipeline stages 4. In this example, the pipeline stages 4 include a fetch stage 6 for fetching instructions from an instruction cache 8; a decode stage 10 for decoding the fetched program instructions to generate micro-operations (decoded instructions) to be processed by remaining stages; an issue stage 12 for checking whether operands required for the micro-operations are available in a register file 14 and scheduling micro-operations for execution once the required operands for a given micro-operation are available; an execute stage 16 for executing data processing operations corresponding to the micro-operations, by processing operands read from the register file 14 to generate result values; and a writeback stage 18 for writing the results of the processing back to the register file 14. It will be appreciated that this is merely one example of possible pipeline architecture, and other systems may have additional stages or a different configuration of stages. For example in an out-of-order processor an additional register renaming stage could be included for mapping architectural registers specified by program instructions or micro-operations to physical register specifiers identifying physical registers in the register file 14. In some examples, there may be a one-to-one relationship between program instructions decoded by the decode stage 10 and the corresponding micro-operations processed by the execute stage. It is also possible for there to be a one-to-many or many-to-one relationship between program instructions and micro-operations, so that, for example, a single program instruction may be split into two or more micro-operations, or two or more program instructions may be fused to be processed as a single micro-operation.

The execute stage 16 includes a number of execution units, for executing different classes of processing operation. In this example the execution units include an arithmetic/logic unit (ALU) 20 for performing arithmetic or logical operations; a floating-point unit 22 for performing operations on floating-point values, a branch unit 24 for evaluating the outcome of branch operations and adjusting the program counter which represents the current point of execution accordingly; and a load/store unit 28 for performing load/store operations to access data in a memory system 8, 30, 32, 34. In this example the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 28 shown in the execute stage 16 are just one example, and other implementations may have a different set of processing units or could include multiple instances of the same type of processing unit so that multiple micro-operations of the same type can be handled in parallel. It will be appreciated that FIG. 1 is merely a simplified representation of some components of a possible processor pipeline architecture, and the processor may include many other elements not illustrated for conciseness, such as branch prediction mechanisms or address translation or memory management mechanisms.

The issue stage 12 is configured to schedule operations to a plurality of optional processing queues 36, and each processing queue 36 causes a scheduled operation to be executed by the execute stage 16. The processing queues 36 act in parallel, such that if an operation is scheduled to queues 36-1 and 36-2, they will both be executed by the execute stage 16 in the same cycle. The data processing apparatus 2 may be provided with any number of processing queues 36, including queue 36-1 to queue 36-N, such that N scheduled operations may be executed by the execution circuitry 16 in the same cycle.

Note that the processing queues themselves are optional. Instructions could be issued straight from the issue stage 12 to the execution units 16.

When issuing operations to the processing queues 36, the issue stage 12 identifies operations that can be scheduled together, referred to as multiple-issue operations herein. Multiple-issue operations may be scheduled to a plurality of the processing queues 36 for performance in the same cycle. Alternatively, multiple-issue operations may be scheduled to one processing queue with an indication that one or more following operations are to be performed in the same cycle. Such an indication may be 2 bits used to identify up to 4 subsequent operations to perform in the same cycle. For example, operations that use different execution units, such as an arithmetic operation and a branch operation could be scheduled together. The issue stage 12 further identifies operations that cannot be scheduled together with another operation, referred to as single-issue operations herein. Single-issue operations are operations that use enough execution resources such that another operation could not be executed at the same time. When the issue stage 12 schedules a single-issue operation to one of the processing queues 36, scheduling is suppressed for the other of the processing queues 36. In some examples, suppressing the scheduling includes stalling those processing queues 36.

In accordance with the present techniques, the data processing apparatus 2 is provided with determination circuitry 38 coupled to the issue stage 12. The determination circuitry is configured to monitor a stream of decoded operations from the decode stage 10 to identify one or more operations as a variable-issue operation. A variable-issue operation could be either a single-issue or multiple-issue operation depending on the particular state of execution of a program. Once a variable-issue operation has been identified, the determination circuitry performs a determination of whether the variable-issue operation is a single-issue or multiple-issue operation, and causes the issue stage 12 to schedule the variable-issue operation according to the determination.

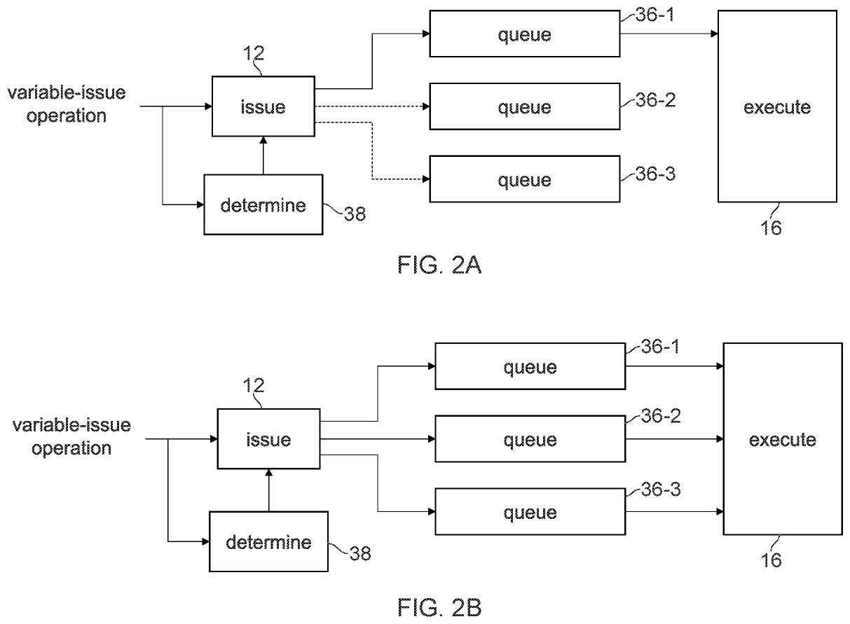

FIGS. 2A and 2B schematically illustrate the apparatus according to the present techniques in isolation. In these examples, there are only three processing queues 36-1, 36-2 and 36-3.

FIG. 2A illustrates the variable-issue operation being identified by the determination circuitry 38. In this example, the determination circuitry 38 determines that the variable-issue operation is a single-issue operation. For example, the variable-issue operation may require a significant amount of execution resources, thus preventing any other operations from being performed (e.g. issued) during the same cycle. In response to the determination, the determination circuitry 38 causes the issue stage 12 to schedule the variable-issue operation as a single-issue operation to only one of the processing queues 36-1. The issue stage 12 suppresses the scheduling of other operations to the remaining processing queues 36-2 and 36-3. The processing queue 36-1 then causes the variable-issue operation to be executed by the execute stage 16.

In FIG. 2B the variable-issue operation is identified similarly to before. However in this example, the determination circuitry 38 determines that the variable-issue operation is a multiple-issue operation. For example, the variable-issue operation may require a relatively small amount of the execution resources, thus allowing at least one other operation to be performed during the same cycle. In response to the determination, the determination circuitry 38 causes the issue stage 12 to schedule the variable-issue operation as a multiple-issue operation to processing queues 36-1. The issue stage 12 may then further schedule other multiple-issue operations to the other processing queues 36-2 and 36-3. All three processing queues 36 then cause the scheduled operations to be execute by the execute stage 16 during the same cycle. It will be appreciated that it is not necessary that multiple-issue operations are scheduled for all processing queues 36. In some examples, multiple-issue operations may be scheduled only for a subset of the processing queues 36, such as processing queues 36-1 and 36-2, whereas scheduling is suppressed for processing queue 36-3.

In accordance with the present techniques, operations that are identified as variable-issue operations may be determined to be either single-issue or multiple-issue depending on the state of processing at runtime. This improves the flexibility of the system as compared to operations which may only be performed as single-issue or multiple-issue operations.

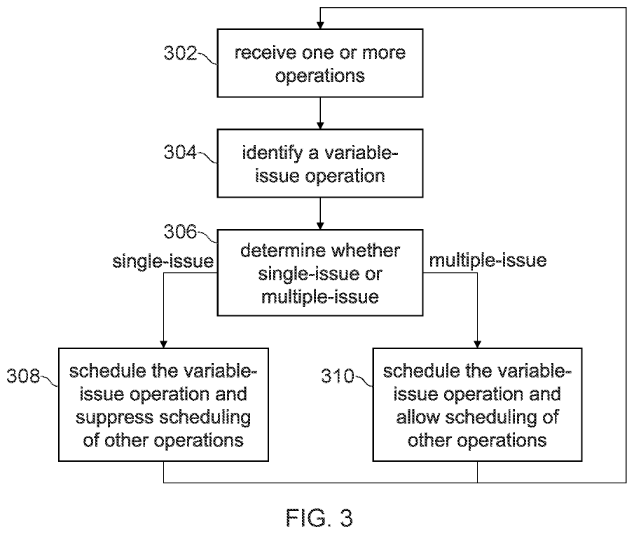

FIG. 3 illustrates a flow diagram for the operation of the apparatus according to the present techniques. At step 302, one or more operations are received from the decode stage 10. At step 304, at least one of the received operations is identified as a variable-issue operation by the determination circuitry 38. At step 306, the determination circuitry performs a determination of whether the variable-issue operation is a single-issue operation or a multiple-issue operation. In response to a determination that the variable-issue operation is a single-issue operation, then at step 308, the issue stage 12 is caused to schedule the variable-issue operation as a single-issue operation and suppresses the scheduling of other operations. On the other hand, in response to a determination that the variable-issue operation is a multiple-issue operation, then at step 310, the issue stage 12 is caused to schedule the variable-issue operation as a multiple-issue operation and allows the scheduling of other operations. After steps 308 or 310, the process returns to step 302 and continues to monitor the received operations.

The determination circuitry 38 can perform the above-described determination in several different ways.

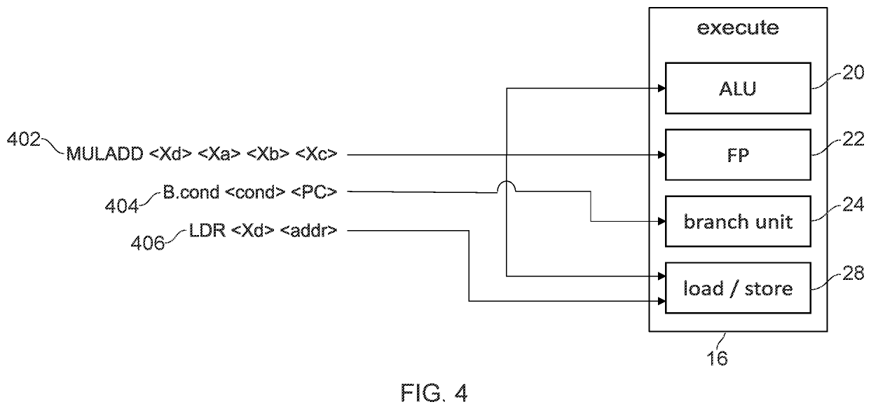

In some examples, the determination circuitry 38 is responsive to a particular class of processing operation specified by the variable-issue operation. As described above in relation to FIG. 1, specific classes of processing operation may use specific execution units in the execution stage 16. FIG. 4 illustrates several examples of data processing instructions that could be executed by the execute stage 16.

Firstly, a multiply-and-add instruction 402 may be received, encoded to include an opcode represented by ‘MULADD’, a destination register and three source registers. When performed, this instruction 402 multiplies the values in two of the source registers, adds the multiplication result to the value in the third source register, and then writes a final result to the destination register. It is recognised that this instruction 402 may require use of the ALU 20, the floating point unit 22 and possibly the load/store unit 28 for loading data from the cache 30.

Secondly, a conditional branch instruction 404 may also be received, encoded to include an opcode represented by ‘B.cond’ and specifies a condition and a program counter value to branch to if the condition is satisfied. This instruction 404 only requires use of the branch unit 24.

Finally, a load instruction 406 may also be received, encoded to include an opcode represented by ‘LDR’ and defines a destination register and a memory address from which to load data. This instruction 406 only requires use of the load/store unit 28.

In response to detecting these instructions and identifying any generated operations as variable-issue operations, the determination circuitry 38 is configured to identify the required execution units for use in the determination of whether those variable-issue operations are to be single-issue or multiple-issue. For example, the multiply-and-add instruction 402 could be performed in the same cycle as the conditional branch instruction 404 since they do not need to share any execution resources. Therefore, those instructions are determined to be multiple-issue operations and scheduled accordingly. On the other hand, the multiply-and-add instruction 402 and the load instruction 406 could conflict if performed in the same cycle, since they both require use of the load/store unit 28. Therefore, at least one of those instructions are determined to be single-issue operations and scheduled accordingly.

In this example, one efficient way to schedule these instructions 402, 404, 406 is to schedule the multiply-and-add instruction 402 and the conditional branch instruction 404 in the same cycle, and then the load instruction 406 in a different cycle. As such, these instructions may be performed in fewer cycles than if they had each been single-issued, thus improving performance.

In some examples, the determination circuitry 38 may instead refer to a threshold value to define whether it may be assumed that more than more than one operation cannot be performed in the same cycle. For example, a threshold value of 3, (i.e. most of the available execution units in the execute stage 16) would result in the multiply-and-add instruction 402 being scheduled as a single-issue operation in one cycle since it requires use of 3 different execution units. In the following cycle, the conditional branch instruction 404 and the load instruction 406 are scheduled as multiple-issue operations. Similar to above, this allows these instructions to be performed in fewer cycles than if they had each been single-issued, thus improving performance. Moreover, a determination based on the threshold value can be performed more quickly performed than analysing whether there will be conflicts due to shared use of certain execution units. It will be appreciated that the threshold value will need to be set such that statistically, conflicts are avoided sufficiently to not hinder performance (e.g. due to execution errors, etc). The threshold value may depend on the particular program being executed or may be adjusted over time depending on whether conflicts are detected.

In some examples, the determination circuitry 38 could identify that the variable-issue operation is logically equivalent to a no-operation (NOP) or is operationally null. To do so, the determination circuitry 38 can determine a number of bytes that is to be operated on by the variable-issue operation. In such examples, the variable-issue operation is configured to operate on a controllable number of bytes that may be an input operand defined in an instruction or set by a previously performed operation. If the number of bytes is equal to zero, then the determination circuitry 38 can determine that the variable-issue operation will not do anything and is hence logically equivalent to a NOP.

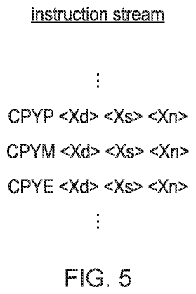

As a specific embodiment of the present techniques, the variable-issue operation may be an operation generated in response to decoding a memory block instruction. FIG. 5 illustrates an instruction stream showing a series of memory block copy instructions including a prologue instruction, main instruction and epilogue instruction. These instructions each define three registers storing a destination address (Xd), a start address (Xs) and a number of bytes to copy (Xn). When received by the decode stage 10, the prologue, main and epilogue instructions are decoded into prologue, main and epilogue operations respectively.

It will be appreciated that the memory block instructions do not need to embody a series of three instructions as in FIG. 5. In other examples, a single memory block instruction may be decoded into prologue, main and epilogue operations. This technique is also not limited only to memory block copy instructions. Other memory block instructions, such as a memory block set instruction, could also be used in an analogous way. However, for ease of explanation, the following examples will specifically relate to memory block copy instructions.

The prologue operation performs an initial copy and alignment of data for the main operation. The main operation then typically performs the majority of the copy, and may repeat one or more times to copy the required amount of data. The epilogue operation then performs the last part of the copy after the main operation(s) has been completed.

In accordance with the present techniques, the prologue operation will typically be scheduled as a single-issue operation. Since the number of bytes to be copied by the main and epilogue operations is dependent on the number of bytes copied by the prologue operation, for particularly small copies the main and epilogue operations could be logically equivalent to a NOP. Therefore, the main and epilogue operations are identified as variable-issue operations such as in previous examples. Accordingly, the determination circuitry 38 is configured to determine whether a main operation that follows a prologue operation will be logically equivalent to a NOP, and hence whether the main operation would be scheduled as a single-issue operation or a multiple-issue operation.

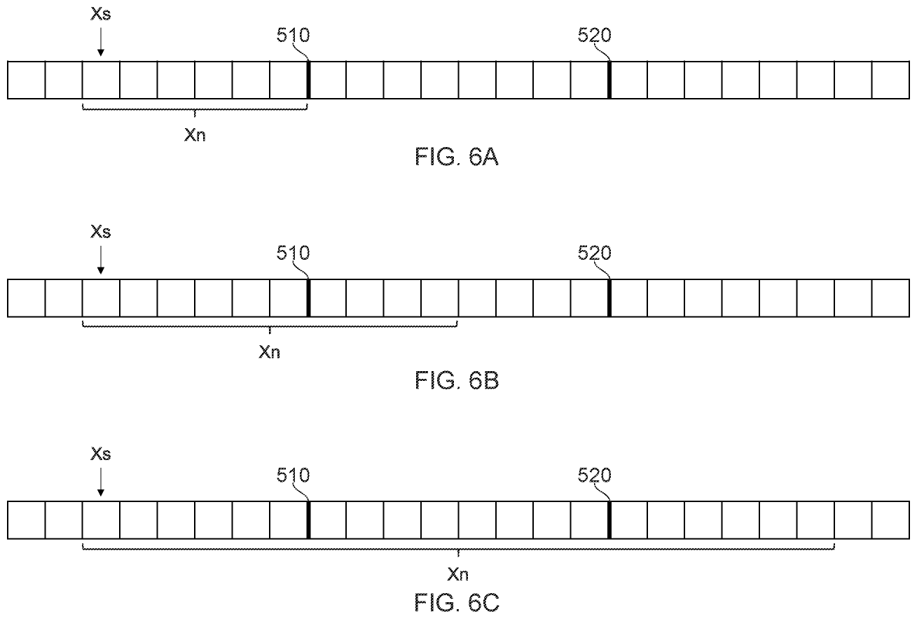

FIGS. 6A to 6C illustrate how certain input operands for a memory block copy instruction could result in one or more operations which are logically equivalent to a NOP. These examples use memory system which is split between alignment boundaries 510, 520 occurring every 8 bytes. It will also be appreciated that the alignment boundaries may be positioned with any other regular spacing depending on the memory system implementation.

FIG. 6A illustrates an example where because of the location of Xs, Xn is small enough that the memory block copy can be completed during the alignment process by the prologue operation. In particular, the prologue operation performs a memory copy on an initial number of bytes up to a first alignment boundary 510. Xs and Xn are such that the main and epilogue operations will have nothing left to copy. The determination circuitry 38 is configured to determine the initial number of bytes to be operated on by the prologue operation. This is determined based on the starting offset from the first alignment boundary 510 given by the 3 least-significant-bits of Xs (note that Xd could be used instead of Xs in the following examples). For example, a byte that is aligned would have an offset of 0, the next byte would have an offset of 1, the next byte would have an offset of 2, and so on. It will be appreciated that the number of least-significant-bits to define the offset will be different depending on the memory system implementation (e.g. for an implementation with alignment boundaries at 16-byte intervals, the starting offset will be the 4 least-significant-bits of Xs or Xd).

In FIG. 6A, the starting byte has an offset of 2 (i.e. Xs identifies the third byte from the alignment boundary). Accordingly, the determination circuitry 38 is configured to identify the prologue operation and obtain Xn, =6 and Xs[0:2]=2 to determine that Xs[0:2]+Xn=8. The determination circuitry 38 then compares this result to the alignment boundary separation (i.e. 8 bytes). If the result is less than or equal to the alignment boundary separation, then it is determined that the total number of bytes will be operated on by the prologue operation. Therefore, the main and epilogue operations are determined as having nothing left to do. The issue stage 12 therefore schedules the main and epilogue operations as multiple-issue operations. In particular, the main and epilogue operations are scheduled as null operations.

FIG. 6B illustrates an example where Xn is too large to be completed by the prologue operation alone. As above, the prologue operation performs a memory copy operation up to the first alignment boundary 510. Since Xs is the same, the initial number of bytes operated on by the prologue operation is the same as in FIG. 6A. However, in this example Xn=14 and so Xn+Xs[0:2]=16. Therefore to complete the copy, the main operation is performed for the 4 bytes that are to be copied between the first memory boundary 510 and a second memory boundary 520. The 4 bytes to be copied by the main operation (i.e. between the alignment boundary 510 and the end of Xn) represents the controllable number of bytes as defined in the claims. Since the controllable number of bytes is not equal to zero, the main operation is not logically equivalent to a NOP in this example.

Xn is still small enough to be completed by the prologue and main operations, such that the epilogue operation will have nothing left to copy. In such examples, the determination circuitry 38 identifies the epilogue operation as a further variable-issue operation and performs a further determination of whether the epilogue operation is logically equivalent to a NOP.

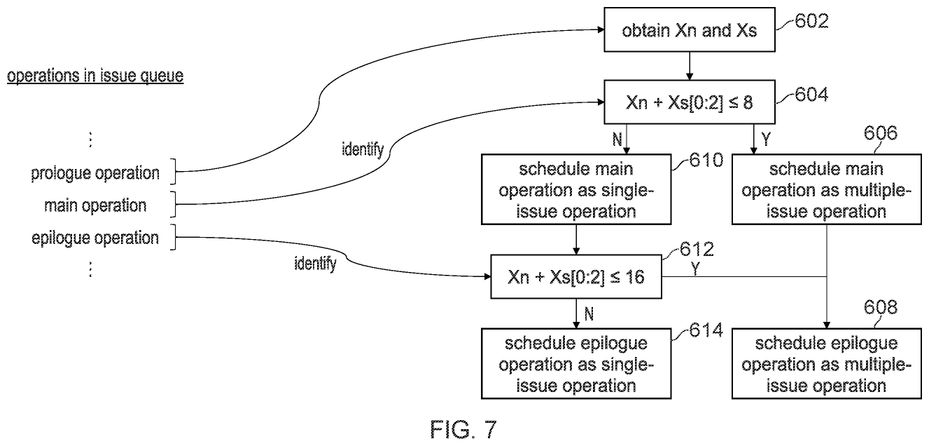

FIG. 7 illustrates the steps to be performed by the determination circuitry 38 in to determine whether the epilogue operation is logically equivalent to a NOP. In step 602, the values for Xn and Xs are obtained by the determination circuitry. In step 604, the determination of whether the prologue operation will complete the copy is made, as described above with reference to FIG. 6A. For the epilogue operation, it is recognised that if the main operation has nothing left to copy, then it can be safely assumed that the epilogue also has nothing left to copy (i.e. as in FIG. 6A). Therefore, if the main operation is scheduled as a multiple-issue operation at step 606, then the epilogue operation can also be scheduled as a multiple-issue operation at step 608.

However if the main operation is required, the main operation is scheduled as a single-issue operation in step 610. In step 612, the determination circuitry 38 determines whether Xn+Xs[0:2] exceeds the maximum number of bytes that can be copied by the prologue and main operations (i.e. 2×8=16 bytes in this example). If not, as in FIG. 6B, then the epilogue operation is determined to be logically equivalent to a NOP, and can be scheduled as a multi-issue operation at step 608.

Referring now to FIG. 6C, the total number of bytes to be copied could be large enough to require the epilogue operation to be performed past the second memory boundary 520. As above, since Xs is the same as previous examples, the initial number of bytes is the same as in FIGS. 6A and 6B. The controllable number of bytes operated on by the main operation is now the number of bytes between alignment boundaries 510 and 520 (i.e. 8 bytes). In this example, Xn=20 and so Xn+Xs[0:2]=22. Accordingly, at step 612 of FIG. 7, the determination circuitry 38 would determine that Xn+Xs[0:2] exceeds the maximum number of bytes to be copied by the prologue and the main operations. Hence, the epilogue operation is not logically equivalent to a NOP and is scheduled as a single-issue operation in step 614.

It is clear from the above examples that whether or not the operations that are logically equivalent to NOPs vary depending on the total size of the copy which may only be known at runtime. According to the present techniques, the operations can be determined to be logically equivalent to NOPs at runtime. In response, the issue stage 12 schedules those operations as null operations, which are multiple-issue operations. Therefore the issue circuitry 12 is also able to schedule further operations in the same cycle, thus increasing the operation throughput and improving performance.

In summary of the above examples, the determination circuitry 38 could be implemented to maintain a set of status flags. The status flags may be defined by the following equations:

$$\begin{matrix}sizezero = ( Xn == 0 ) \\ {nop}_{m a i n} = ( X n + X s [ 0 : 3 ] ) \leq 8 \vert sizezero \\ {nop}_{e p i l o g u e} = ( X n + X s [ 0 : 3 ] ) \leq 16 \vert sizezero\end{matrix}$$

If the status flag for ‘nopₘₐᵢₙ’ is set to true, then the determination circuitry 38 has determined that the main operation is logically equivalent to a NOP and can be scheduled as a multiple-issue operation. Similarly, if the status flag for ‘nop_{epilogue}’ is set to true, then the determination circuitry 38 has determined that the epilogue operation is logically equivalent to a NOP and can be scheduled as a multiple-issue operation.

As mentioned above, the comparison value depends on the particular implementation of the memory system and the separation of alignment boundaries. In examples where the alignment boundaries are in 16-byte intervals, the status flags may be defined by the following equations instead:

$$\begin{matrix}{nop}_{m a i n} = ( X n + X s [ 0 : 3 ] ) \leq 16 \vert sizezero \\ {nop}_{e p i l o g u e} = ( X n + X s [ 0 : 3 ] ) \leq 32 \vert sizezero\end{matrix}$$

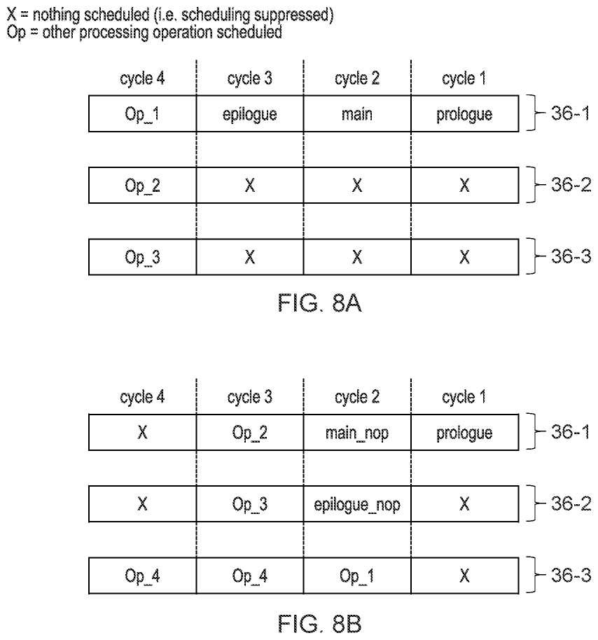

FIGS. 8A and 8B illustrate the scheduling history in the processing queues 36 of some of the above examples to show the potential advantages where the main and/or epilogue operations are determined to be logically equivalent to NOPs and then scheduled as multiple-issue operations.

FIG. 8A illustrates an example where the prologue, main and epilogue operations are all scheduled as single-issue operations (e.g. as in FIG. 6C). Each operation is scheduled in processing queue 36-1 for one cycle. Since they are each single-issue operations, the scheduling of further operations in processing queues 36-2 and 36-3 is suppressed. Hence, those queues 36-2, 36-3 are effectively stalled during cycles 1 to 3. At cycle 4, a new operations Op_1 is scheduled as a multiple-issue operation in processing queue 36-1 with operations Op_2 and Op_3 also scheduled in processing queue 36-2 and 36-3 in the same cycle.

In FIG. 8B illustrates an example where the main and epilogue operations are determined to be logically equivalent to a NOP (e.g. as in FIG. 6A). In this example, the prologue operation is scheduled for cycle 1 while the determination circuitry 38 performs the calculations described above to determine whether the main and epilogue operations are logically equivalent to a NOP. In cycle 2, the main and epilogue operations are scheduled as null operations in processing queues 36-1 and 36-2. Since the null operations are multiple-issue operations, Op_1 can also be scheduled for cycle 2 in processing queue 36-3. Additional multiple-issue operations (i.e. Op_2, Op_3, etc.) are scheduled for cycles 3 and 4. Also in this example, it is shown how scheduling may be suppressed when an operation (i.e. Op_4) requires more than one cycle to be performed. In particular, Op_4 is scheduled to be performed at cycle 3 and is still being performed in cycle 4. Therefore, scheduling of an operation in processing queue 36-3 in cycle 4 is suppressed. This provides an example of where ‘at least the given cycle’ can be considered multiple cycles.

Similarly, if Op_2 were to take multiple processor cycles and was determined to be multiple issue, then Op_4 could remain scheduled in one processing queue 36-3 and even a further operation Op_5 could be scheduled in another processing queue 36-2 (presuming Op_4 and Op_5 were such that they could be scheduled together—e.g. provided they were equivalent to NOPs).

These figures show that when the main and epilogue operations are determined to be logically equivalent to NOPs, later operations can be scheduled sooner. In particular in the example of FIG. 8B, three additional operations can be scheduled in the same number of cycles as compared to FIG. 8A.

In some examples, the calculation performed by the determination circuitry 38 requires at least one cycle to complete. In other examples, the calculation can be simplified to speed up the determination by simplifying the calculation of how many bytes will be copied by the prologue operation as part of the alignment process. In particular, the simplification removes the determination of the initial number of bytes operated on by the prologue operation, thus removing the addition in steps 604 or 612 of FIG. 7.

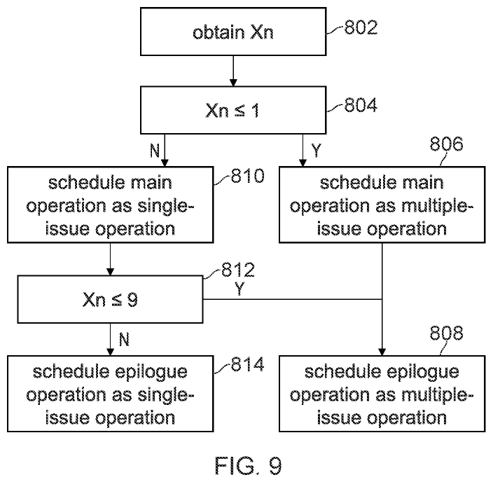

An example of a faster calculation performed by the determination circuitry 38 is illustrated in FIG. 9. At step 802, the determination circuitry 38 obtains the values for Xn. Since the calculation does not consider the alignment process and instead assumes a “worst case” scenario where the alignment process is as small as possible, the value for Xs or Xd is not necessary. At step 804, the determination circuitry 38 determines whether Xn is less than or equal to 1. In some examples, this determination could be performed with an ‘or’ gate. If Xn is 1 byte, then regardless of how much alignment is required, the prologue operation will complete the copy. Therefore, the main and epilogue operations can be quickly determined to be logically equivalent to NOPs with certainty. Accordingly at steps 806 and 808, the main and epilogue operations are scheduled as multiple-issue operations as in previous examples.

If Xn exceeds 1 byte, then the main operation cannot be determined with certainty to be logically equivalent to a NOP. Therefore in this faster example, the main operation is scheduled as a single-issue operation at step 810. At step 812, it is determined whether Xn is less than or equal to 9 bytes (note that this example still assumes an 8-byte memory system as in previous examples). If Xn is less than or equal to 9 bytes, then regardless of the start address, the prologue and main operation will complete the copy. Therefore the epilogue operation can be quickly determined to be logically equivalent to a NOP with certainty. Depending on the outcome of step 812, the epilogue operation can then be scheduled as a multiple-issue operation at step 808 or a single-issue operation at step 814.

In these faster examples, the determination circuitry 38 can maintain status flags according to the following equations:

$$\begin{matrix}no {p}_{m a i n} = X n \leq 1 \\ no {p}_{e p i l o g u e} = X n \leq 9\end{matrix}$$

Also as above, it will be appreciated that for memory systems with other alignment boundary intervals, these equations would be different. For example, for alignment boundaries with 16-byte intervals, the equations would be:

$$\begin{matrix}no {p}_{m a i n} = X n \leq 1 \\ no {p}_{e p i l o g u e} = X n \leq 17\end{matrix}$$

Note that the status for ‘nopₘₐᵢₙ’ is always dependent on a comparison of the total size with 1. The status for ‘nop_{epilogue}’ is dependent on the alignment boundary interval plus 1.

In these faster examples, it is possible for determination circuitry 38 to determine whether the main and epilogue operations could be scheduled as null operations in the same cycle as the prologue operation. However, there is a greater risk of the determination circuitry 38 missing potential opportunities for performance gain.

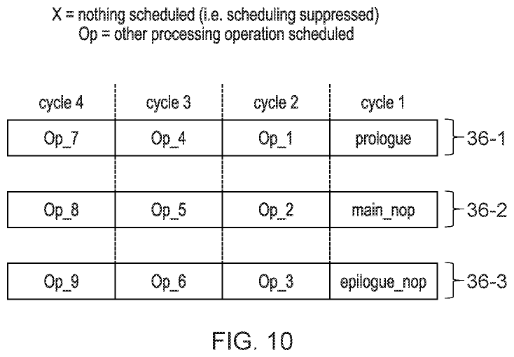

FIG. 10 illustrates the processing queues 36 according to the present faster example. Since the determination circuitry 38 performs the determination faster due to the above-described simplification, all of the prologue, main and epilogue operations are scheduled in cycle 1, with the main and epilogue operations being replaced with null operations. Cycle 2 is now available in all processing queues 36 for new operations (Op_1, Op_2, etc.). In this example, three additional operations can be scheduled in the same number of cycles compared to the example of FIG. 8B.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

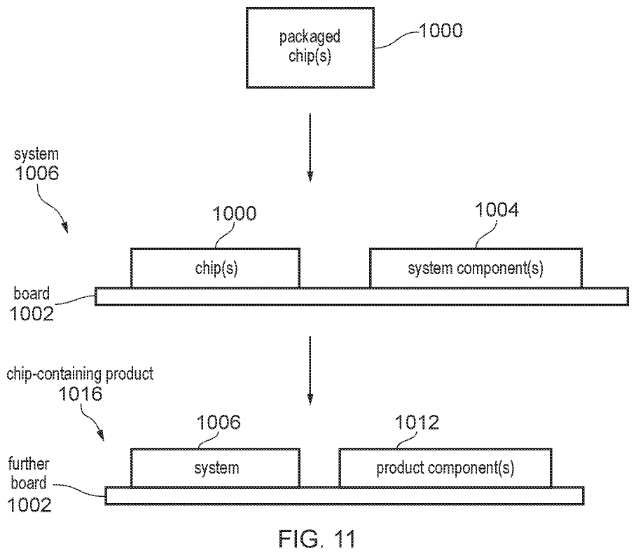

As shown in FIG. 11, one or more packaged chips 1000, with the apparatus described above implemented on one chip or distributed over two or more of the chips, are manufactured by a semiconductor chip manufacturer. In some examples, the chip product 1016 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 1000 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. small modular chips with particular functionality) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 1000 are assembled on a board 1002 together with at least one system component 1004 to provide a system 1006. For example, the board may comprise a printed circuit board. The board substrate may be made of any of a variety of materials, e.g. plastic, glass, ceramic, or a flexible substrate material such as paper, plastic or textile material. The at least one system component 1004 comprise one or more external components which are not part of the one or more packaged chip(s) 1000. For example, the at least one system component 1004 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 1016 is manufactured comprising the system 1006 (including the board 1002, the one or more chips 1000 and the at least one system component 1004) and one or more product components 1012. The product components 1012 comprise one or more further components which are not part of the system 1006. As a non-exhaustive list of examples, the one or more product components 1012 could include a user input/output device such as a keypad, touch screen, microphone, loudspeaker, display screen, haptic device, etc.; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 1006 and one or more product components 1012 may be assembled on to a further board 1014.

The board 1002 or the further board 1014 may be provided on or within a device housing or other structural support (e.g. a frame or blade) to provide a product which can be handled by a user and/or is intended for operational use by a person or company.

The system 1006 or the chip-containing product 1016 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Some examples are set out in the following clauses:
(1) An apparatus comprising:
   scheduling circuitry configured to schedule one or more operations to be performed in at least a given cycle;
   determination circuitry configured to identify one of the one or more operations as a variable-issue operation and to perform a determination of whether the variable-issue operation is a single-issue operation or a multiple-issue operation;
   the scheduling circuitry is configured to schedule the variable-issue operation to be performed in at least the given cycle, wherein
   in response to the determination being that the variable-issue operation is the single-issue operation, the determination circuitry is configured to cause the scheduling circuitry to suppress scheduling of the one or more operations other than the variable-issue operation to be performed in at least the given cycle; and
in response to the determination being that the variable-issue operation is the multiple-issue operation, the determination circuitry is configured to cause the scheduling circuitry to schedule at least one of the one or more operations other than the variable-issue operation to be performed in at least the given cycle.
(2) The apparatus of clause (1), comprising: Execution circuitry configured to perform scheduled operations; and
   the determination circuitry is configured to perform the determination by detecting whether the variable-issue operation and the at least one of the one or more operations other than the variable-issue operation can be performed by the execution circuitry in at least the given cycle.
(3) The apparatus of clause (2), wherein
   the execution circuitry comprises a plurality of operational units; and
   in response to the variable-issue operation requiring use of a threshold number of the operational units, the determination circuitry is configured to perform the determination such that the determination is that the variable-issue operation is a single-issue operation.
(4) The apparatus of any preceding clause, wherein
   in response to the variable-issue operation being logically equivalent to a NOP operation or operationally null, the determination circuitry is configured to perform the determination and determine that the variable-issue operation is the multiple-issue operation.
(5) The apparatus of any preceding clause, wherein
   in response to the variable-issue operation having nothing to do, the determination circuitry is configured to perform the determination and determine that the variable-issue operation is the multiple-issue operation.
(6) The apparatus of any preceding clause, wherein
   the variable-issue operation is configured, when executed, to operate on a controllable number of bytes of a memory; and
   the determination circuitry is configured to perform the determination and determine that the variable-issue operation is the multiple-issue operation in response to the controllable number of bytes on which the variable-issue operation is performed being zero.
(7) The apparatus of any preceding clause, wherein
   in response to the determination that the variable-issue operation is the multiple-issue operation, the scheduling circuitry is configured to schedule the variable-issue operation as a null operation to be performed in at least the given cycle.
(8) The apparatus of any preceding clause, wherein
   the determination circuitry is configured to identify a prologue operation preceding the variable-issue operation; and
   the determination circuitry is configured to perform the determination and determine that the variable-issue operation is the multiple-issue operation in response to a behaviour of the prologue operation.
(9) The apparatus of clause (8), wherein
   the determination circuitry is configured to perform the determination and determine that the variable-issue operation is the multiple-issue operation in response to an extent to which the prologue operation is performed.
(10) The apparatus of clause (8) or clause (9), wherein
   the prologue operation is configured, when performed, to operate on an initial number of bytes of the memory; and
   the determination circuitry is configured to perform the determination and determine that the variable-issue operation is the multiple-issue operation in response to the initial number of bytes being such that there is nothing left for the variable-issue operation to do.
(11) The apparatus of any of clauses (8) to (10), wherein
   the prologue operation and the variable-issue operation are generated in response to decoding of at least one memory block instruction indicating a total number of bytes of the memory.
(12) The apparatus of clause (11), wherein
   the memory block instruction is either a memory block copy instruction or a memory block set instruction.
(13) The apparatus of clause (11) or clause (12), wherein
   the determination circuitry is configured to perform the determination and determine that the variable-issue operation is the multiple-issue operation in response to the prologue operation operating on all of the total number of bytes of the memory.
(14) The apparatus of any of clauses (11) to (13), wherein
   the prologue operation is configured to perform an alignment process such that the variable-issue operation, when performed, is aligned with a memory boundary, and
   the determination circuitry is configured to perform the determination and determine that the variable-issue operation is the multiple-issue operation in response to the alignment process comprising operating on all of the total number of bytes of memory.
(15) The apparatus of any of clauses (8) to (14), wherein
   the determination circuitry is configured to identify an epilogue operation following the variable-issue operation;
   the determination circuitry is configured to perform a further determination of whether the epilogue operation is the single-issue operation or the multiple-issue operation in response to a behaviour of the variable-issue operation.
(16) The apparatus of clause (15), wherein
   the determination circuitry is configured to perform the further determination and determine that the epilogue operation is the multiple-issue operation in response to the determination being that the variable-issue operation is the multiple-issue operation.
(17) The apparatus of clause (15) or clause (16), wherein
   the determination circuitry is configured to perform the further determination and determine that the epilogue operation is the multiple-issue operation in response to the variable-issue operation being performed to an extent such that there is nothing left for the epilogue operation to do.
(18) The apparatus of any of clauses (15) to (17), wherein
   the prologue operation, the variable-issue operation and the epilogue operation are generated in response to decoding of at least one memory block instruction, indicating a total number of bytes of the memory;
   the determination circuitry is configured to perform the determination and determine that the variable-issue operation is the multiple-issue operation in response to the total number of bytes being less than or equal to 1; and
   the determination circuitry is configured to perform the further determination and determine that the epilogue operation is the multiple-issue operation in response to the total number of bytes being less than or equal to an alignment boundary interval plus 1.
(19) A system comprising:
   the apparatus of any of clauses (1) to (18), implemented in at least one packaged chip;
   at least one system component; and
   a board,
   wherein the at least one packaged chip and the at least one system component are assembled on the board.
(20) A chip-containing product comprising the system of clause (19) assembled on a further board with at least one other product component.
(21) A method comprising:
   scheduling one or more operations to be performed in at least a given cycle;
   identifying one of the one or more operations as a variable-issue operation and performing a determination of whether the variable-issue operation is a single-issue operation or a multiple-issue operation;
   scheduling the variable-issue operation to be performed in at least the given cycle, wherein
   in response to the determination being that the variable-issue operation is the single-issue operation, suppressing scheduling of the one or more operations other than the variable-issue operation to be performed in at least the given cycle; and
   in response to the determination being that the variable-issue operation is the multiple-issue operation, scheduling at least one of the one or more operations other than the variable-issue operation to be performed in at least the given cycle.
(22) A non-transitory computer-readable medium to store computer-readable code for fabrication of an apparatus comprising:
   scheduling circuitry configured to schedule one or more operations to be performed in at least a given cycle;
   determination circuitry configured to identify one of the one or more operations as a variable-issue operation and to perform a determination of whether the variable-issue operation is a single-issue operation or a multiple-issue operation;
   the scheduling circuitry is configured to schedule the variable-issue operation to be performed in at least the given cycle, wherein
   in response to the determination being that the variable-issue operation is the single-issue operation, the determination circuitry is configured to cause the scheduling circuitry to suppress scheduling of the one or more operations other than the variable-issue operation to be performed in at least the given cycle; and
   in response to the determination being that the variable-issue operation is the multiple-issue operation, the determination circuitry is configured to cause the scheduling circuitry to schedule at least one of the one or more operations other than the variable-issue operation to be performed in at least the given cycle.

In the present application, the words “configured to . . . ” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

Although illustrative embodiments of the invention have been described in detail herein with reference to the accompanying drawings, it is to be understood that the invention is not limited to those precise embodiments, and that various changes, additions and modifications can be effected therein by one skilled in the art without departing from the scope and spirit of the invention as defined by the appended claims. For example, various combinations of the features of the dependent claims could be made with the features of the independent claims without departing from the scope of the present invention.

We claim:

1. An apparatus comprising:
scheduling circuitry configured to schedule one or more operations to be performed in at least a given cycle;
determination circuitry configured to identify one of the one or more operations as a variable-issue operation and to perform a determination of whether the variable-issue operation is a single-issue operation or a multiple-issue operation;
the scheduling circuitry is configured to schedule the variable-issue operation to be performed in at least the given cycle, wherein
in response to the determination being that the variable-issue operation is the single-issue operation, the determination circuitry is configured to cause the scheduling circuitry to suppress scheduling of the one or more operations other than the variable-issue operation to be performed in at least the given cycle; and
in response to the determination being that the variable-issue operation is the multiple-issue operation, the determination circuitry is configured to cause the scheduling circuitry to schedule at least one of the one or more operations other than the variable-issue operation to be performed in at least the given cycle.

2. The apparatus of claim 1, comprising:
execution circuitry configured to perform scheduled operations; and
the determination circuitry is configured to perform the determination by detecting whether the variable-issue operation and the at least one of the one or more operations other than the variable-issue operation can be performed by the execution circuitry in at least the given cycle.

3. The apparatus of claim 2, wherein
the execution circuitry comprises a plurality of operational units; and
in response to the variable-issue operation requiring use of a threshold number of the operational units, the determination circuitry is configured to perform the determination such that the determination is that the variable-issue operation is a single-issue operation.

4. The apparatus of claim 1, wherein
in response to the variable-issue operation:
being logically equivalent to a NOP,
being operationally null, or
having nothing to do;
the determination circuitry is configured to perform the determination and determine that the variable-issue operation is the multiple-issue operation.

5. The apparatus of claim 1, wherein
the variable-issue operation is configured, when executed, to operate on a controllable number of bytes of a memory; and
the determination circuitry is configured to perform the determination and determine that the variable-issue operation is the multiple-issue operation in response to the controllable number of bytes on which the variable-issue operation is performed being zero.

6. The apparatus of claim 1, wherein
in response to the determination that the variable-issue operation is the multiple-issue operation, the scheduling circuitry is configured to schedule the variable-issue operation as a null operation to be performed in at least the given cycle.

7. The apparatus of claim 1, wherein
the determination circuitry is configured to identify a prologue operation preceding the variable-issue operation; and
the determination circuitry is configured to perform the determination and determine that the variable-issue operation is the multiple-issue operation in response to an extent to which the prologue operation is performed.

8. The apparatus of claim 7, wherein
the prologue operation is configured, when performed, to operate on an initial number of bytes of the memory; and
the determination circuitry is configured to perform the determination and determine that the variable-issue operation is the multiple-issue operation in response to the initial number of bytes being such that there is nothing left for the variable-issue operation to do.

9. The apparatus of claim 7, wherein
the prologue operation and the variable-issue operation are generated in response to decoding of at least one memory block instruction indicating a total number of bytes of the memory.

10. The apparatus of claim 9, wherein
the memory block instruction is either a memory block copy instruction or a memory block set instruction.

11. The apparatus of claim 9, wherein
the determination circuitry is configured to perform the determination and determine that the variable-issue operation is the multiple-issue operation in response to the prologue operation operating on all of the total number of bytes of the memory.

12. The apparatus of claim 9, wherein
the prologue operation is configured to perform an alignment process such that the variable-issue operation, when performed, is aligned with a memory boundary, and
the determination circuitry is configured to perform the determination and determine that the variable-issue operation is the multiple-issue operation in response to the alignment process comprising operating on all of the total number of bytes of memory.

13. The apparatus of claim 7, wherein
the determination circuitry is configured to identify an epilogue operation following the variable-issue operation;
the determination circuitry is configured to perform a further determination of whether the epilogue operation is the single-issue operation or the multiple-issue operation in response to a behaviour of the variable-issue operation.

14. The apparatus of claim 13, wherein
the determination circuitry is configured to perform the further determination and determine that the epilogue operation is the multiple-issue operation in response to the determination being that the variable-issue operation is the multiple-issue operation.

15. The apparatus of claim 13, wherein
the determination circuitry is configured to perform the further determination and determine that the epilogue operation is the multiple-issue operation in response to the variable-issue operation being performed to an extent such that there is nothing left for the epilogue operation to do.

16. The apparatus of claim 14, wherein
the prologue operation, the variable-issue operation and the epilogue operation are generated in response to decoding of at least one memory block instruction indicating a total number of bytes of the memory;
the determination circuitry is configured to perform the determination and determine that the variable-issue operation is the multiple-issue operation in response to the total number of bytes being less than or equal to 1; and
the determination circuitry is configured to perform the further determination and determine that the epilogue operation is the multiple-issue operation in response to the total number of bytes being less than or equal to an alignment boundary interval plus 1.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17 assembled on a further board with at least one other product component.

19. A method comprising:
scheduling one or more operations to be performed in at least a given cycle;
identifying one of the one or more operations as a variable-issue operation and performing a determination of whether the variable-issue operation is a single-issue operation or a multiple-issue operation;
scheduling the variable-issue operation to be performed in at least the given cycle, wherein
in response to the determination being that the variable-issue operation is the single-issue operation, suppressing scheduling of the one or more operations other than the variable-issue operation to be performed in at least the given cycle; and
in response to the determination being that the variable-issue operation is the multiple-issue operation, scheduling at least one of the one or more operations other than the variable-issue operation to be performed in at least the given cycle.

20. A non-transitory computer-readable medium to store computer-readable code for fabrication of an apparatus comprising:
scheduling circuitry configured to schedule one or more operations to be performed in at least a given cycle;
determination circuitry configured to identify one of the one or more operations as a variable-issue operation and to perform a determination of whether the variable-issue operation is a single-issue operation or a multiple-issue operation;
the scheduling circuitry is configured to schedule the variable-issue operation to be performed in at least the given cycle, wherein
in response to the determination being that the variable-issue operation is the single-issue operation, the determination circuitry is configured to cause the scheduling circuitry to suppress scheduling of the one or more operations other than the variable-issue operation to be performed in at least the given cycle; and
in response to the determination being that the variable-issue operation is the multiple-issue operation, the determination circuitry is configured to cause the scheduling circuitry to schedule at least one of the one or more operations other than the variable-issue operation to be performed in at least the given cycle.
